(19) United States
(12) Patent Application Publication
(10) Pub. No.: US 2006/0272904 A1
(43) Pub. Date: Dec. 7, 2006

(54) Brake adjusting mechanism

(76) Inventor: Kenneth Alan Soellner, Kettering, OH (US)

Correspondence Address: Don W Bulson;Renner Otto Boisselle & Sklar, 1621 Euclid Avenue, 19th Floor, Clevand, OH, 44115, US

(21) Appl. No.: 10/568,550

(22) PCT Filed: Aug. 18, 2004
(86) PCT No.: PCT/US04/26850

§ 371 Date: Jul. 10, 2006

Related U.S. Application Data
(60) Provisional application No. 60/495,990, filed on Aug. 18, 2003.

(51) Int. Cl. F16D 55/02; F16D 65/54

(52) U.S. Cl. 188/71.7; 188/196 R

(57) ABSTRACT

An adjuster assembly (48) for automatically maintaining a uniform release clearance (and therefore a uniform stroke) for brakes and similar equipment. The adjuster assembly (48) comprises a continuous tube (62) and an expansion member (58) together having a combined length controlling the release clearance of selectively engageable friction parts. The expansion member (58) has an expansion device frictionally engaging the interior of the continuous tube (62) to effect progressive circumferential expansion of the continuous tube (62) when the expansion device is axially drawn through the continuous tube to compensate for wear of the friction parts during actuation and release of said selectively engageable parts. Unlike prior art adjuster assemblies, the continuous tube (62) advantageously has an end portion (70) processed differently from the balance of the continuous tube (62) for extending the usable portion of the continuous tube.

### FIELD OF THE INVENTION

This invention relates to adjusting mechanisms for automatically maintaining a uniform release clearance (and therefore a uniform stroke) for brakes and similar equipment. Mechanisms of this type are commonly used in brake systems to compensate for wear of the brake linings and other brake parts and are popularly called “automatic brake adjusters.” Although the present invention is explained herein in connection with brakes, the mechanism has utility in other environments where similar wear compensation is needed such as in clutches.

### BACKGROUND OF THE INVENTION

Brakes heretofore have included mechanical adjusters with special ratchets or friction dragging parts to provide adjustment for wear. Hydraulic adjusters utilizing the metering of hydraulic fluid and adjusters with deformable tubes have also been used.

Also known are mechanical adjusters in which a deforming member is pulled through a ductile deformable tube. These adjusters have the advantage of low cost and reliability. Notwithstanding, there has been a problem of nonuniform resistance to deformation of the tube over its entire length. The deformable tube tends to deform more easily at its longitudinal end portions as opposed to its more central portions.

U.S. Pat. No. 4,171,036 discloses a brake adjuster assembly that includes a tube having an axial slot extending the length thereof that allows for radial expansion of the tube as a deforming member is pulled therethrough. As described, the tube need not be made of a material having any special ductility for expansion and such tube with minor changes can be used for adjusters where the adjusting force is either low or high. Progressive axial movement of a ball in the tube results in progressive expansion of the tube by separation at the slot. The tube also has a flange, a “V” notch or a rough inner surface on its longitudinal end portions to increase resistance to the ball that progresses axially through the tube, thereby giving the tube over its entire length a more uniform resistance to movement of the ball.

Although the split tube of this patent was used, it was not as successful as a “continuous tube,” like those disclosed in later U.S. Pat. Nos. 5,219,046 and 5,538,109.

### DEFINITIONS

As used herein, a “continuous tube” is a tubular member that does not have in the wall thereof an axial slot or separation extending continuously along the “operative length” thereof. The “operative length” of the tubular member is the length of the tubular member that is intended to be radially expanded by a deforming member in providing adjustment for wear. A “continuous tube” as referred to herein can have in the wall thereof openings or separations spaced along the operative length of the tubular member, provided they do not form an axial slot or separation extending continuously along the operative length of the tubular member. A “solid continuous tube” herein means a continuous tube which does not have in the wall thereof any opening or separations along the operative length thereof.

### SUMMARY OF THE INVENTION

The present invention provides an adjuster assembly for automatically maintaining a uniform release clearance (and therefore a uniform stroke) for brakes and similar equipment. The adjuster assembly comprises a continuous tube and an expansion member together having a combined length controlling the release clearance of selectively engageable friction parts. The expansion member has an expansion device frictionally engaging the interior of the continuous tube to effect progressive circumferential expansion of the continuous tube when the expansion device is axially drawn through the continuous tube to compensate for wear of the friction parts during actuation and release of said selectively engageable parts. Unlike prior art adjuster assemblies, the continuous tube advantageously has an end portion processed differently from the balance of the continuous tube for extending the usable portion of the continuous tube.

In a preferred embodiment, the end portion of the continuous tube is shaped to provide over a portion thereof a load resistance essentially equal the load resistance of a cylindrical portion of the continuous tube adjacent the flared end portion. To this end, the end portion is radially inwardly flared, as by swaging, for extending the usable portion of the continuous tube, although other configurations are contemplated. The continuous tube preferably is a solid continuous tube that is cylindrical and the end portion preferably is uniformly radially inwardly flared.

The invention also provides a brake system comprising a plurality of friction discs located between a pressure plate and a reaction plate, an actuating mechanism operative for moving the pressure plate toward the friction discs and the reaction plate, and an adjuster assembly as set forth in claim 1 for compensating for wear of the friction discs.

The invention further provides a method of increasing the useable life of an adjuster tube in an adjuster assembly that adjusts the release clearance between selectively engageable friction parts to compensate for wear in such parts, the adjuster assembly including a continuous tube and an expansion member together having a combined length controlling the release clearance of the selectively engageable friction parts, and the expansion member having an expansion device frictionally engaging the interior of the continuous tube to effect progressive circumferential expansion of the continuous tube when the expansion device is axially drawn through the continuous tube to compensate for wear of the friction parts during actuation and release of said selectively engageable parts, the method comprising the step of processing an end portion of the continuous tube differently from the balance of the continuous tube for extending the usable portion of the continuous tube.

The foregoing and other features of the invention are hereinafter fully described and particularly pointed out in the claims, the following description and annexed drawings setting forth in detail a certain illustrative embodiment of the invention, this embodiment being indicative, however, of but one of the various ways in which the principles of the invention may be employed.

### BRIEF DESCRIPTION OF THE DRAWINGS

FIG. 1 is a cross-sectional view of an aircraft wheel and brake assembly with a piston actuator employing a prior art brake adjustor assembly.

FIG. 2 is a cross-sectional view of the piston actuator employing a brake adjustor assembly according to the present invention.

FIG. 3 is a cross-sectional view of the piston actuator after substantial wear of the brake has been taken up by the brake adjustor assembly.

### DETAILED DESCRIPTION

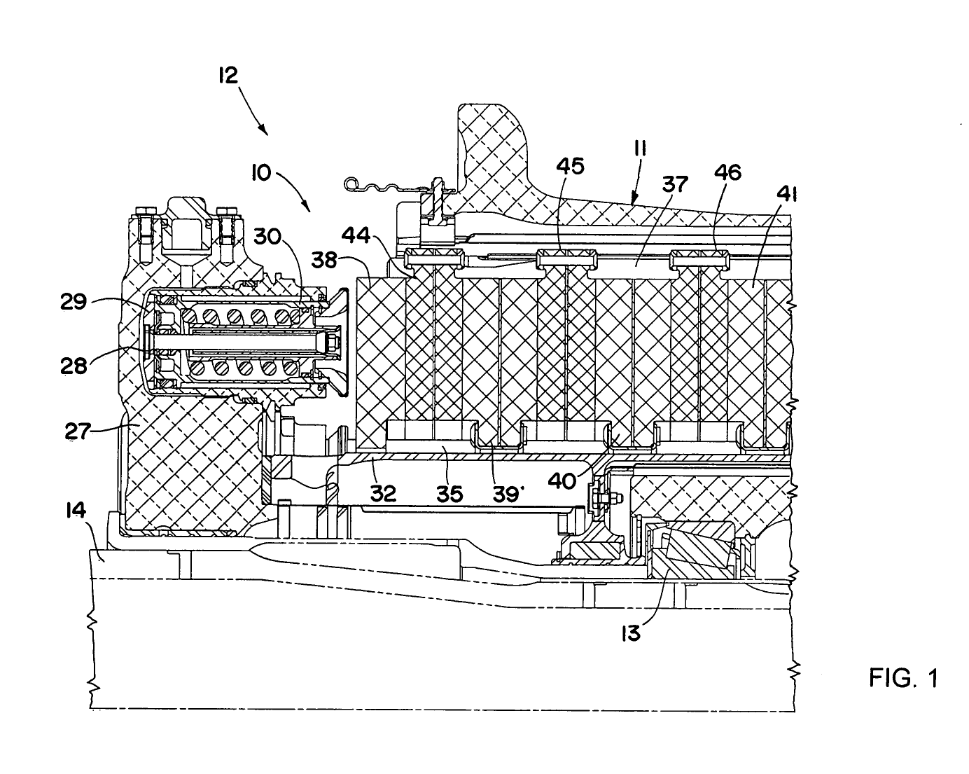

Referring to the drawings, wherein like reference numerals designate like or corresponding parts throughout the several views, there is shown in FIG. 1 an exemplary prior art friction brake mechanism 10 for use with a wheel 11. The brake mechanism and wheel form a wheel and brake assembly 12 particularly suited for use in an aircraft. As shown, the wheel is rotatably mounted by bearings 13 on an axle 14 that can be connected to a landing gear strut or truck in a conventional manner.

The brake mechanism 10 includes a piston housing 27 supported on the axle 14 in a conventional manner. The piston housing 27 has a plurality of circumferentially spaced bores 28 that receive cylinders 29 within which are slidably mounted pistons 30. The piston housing 27 has secured thereto a torque member 32 (commonly referred to as a torque tube or plate) that has an annular and radially outwardly extending reaction member (not shown) at its end opposite the piston housing.

The torque tube 32 has a plurality of circumferentially spaced splines or spline members 35 which are axially extending. The wheel 11 has attached thereto a plurality of circumferentially spaced spline members 37 at its inner peripheral surface. The spline members 35 support an axially nonrotatable end disc or pressure plate 38 and inner nonrotatable stator discs 39, 40 and 41. The end disc 38 and stator discs 39, 40 and 41 have slotted openings at circumferentially spaced locations on the inner periphery for captive engagement by the spline members 35 as is old and well known in the art. Such discs 38, 39, 40 and 41 constitute the stators for the friction brake 10. As is conventional, the previously mentioned reaction member acts in concert with the stator discs. A plurality of axially spaced rotor discs 44, 45 and 46 are interspaced or interleaved between the stator discs 38 through 41. The rotor discs have a plurality of circumferentially spaced openings along their outer periphery for engagement by the corresponding spline members 37 as is old and well known in the art. All of the stator discs 38 through 41 and rotor discs (44 through 46) can be made from a suitable brake material or materials such as metal, steel or other wear-resistant material for withstanding high temperatures and providing a heat sink. The number of discs may be varied as is necessary for the application involved.

The pistons 30 previously referred to are all identical in structure. When the pistons are extended, hydraulically in the illustrated embodiment, they push the stator and rotor discs together and toward the reaction member, whereupon the stators and rotor discs are squeezed together to effect braking. Braking force is released by retracting the pistons. Preferably the pistons are backed off from the pressure plate 38 by a prescribed amount (running clearance). Unless compensated for, the running clearance will increase as the stator and rotor discs wear, as the combined axial thickness thereof will decrease as they wear. Some mechanism is needed to compensate for such wear in order to keep the piston stroke relatively the same regardless of the extent of wear, as is desired. In FIG. 1, the piston 30 is shown with a prior art wear adjustor assembly and details thereof can be obtained by reference to U.S. Pat. No. 5,538,109, which is hereby incorporated herein by reference.

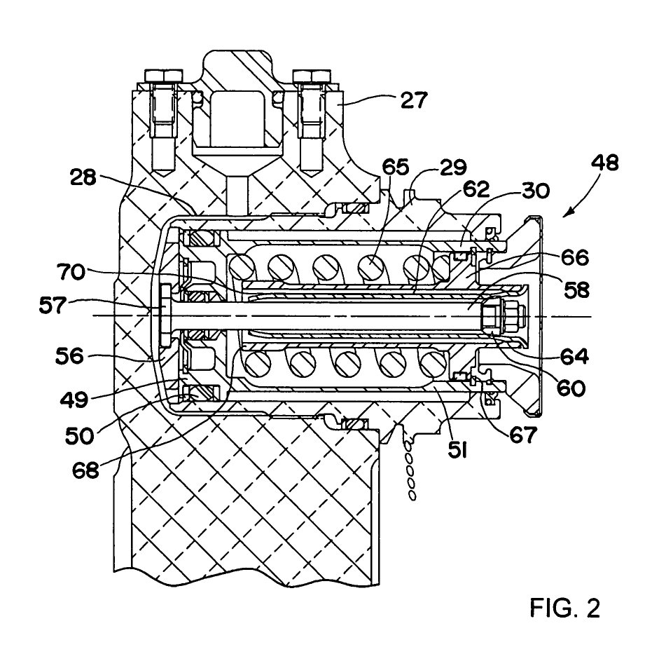

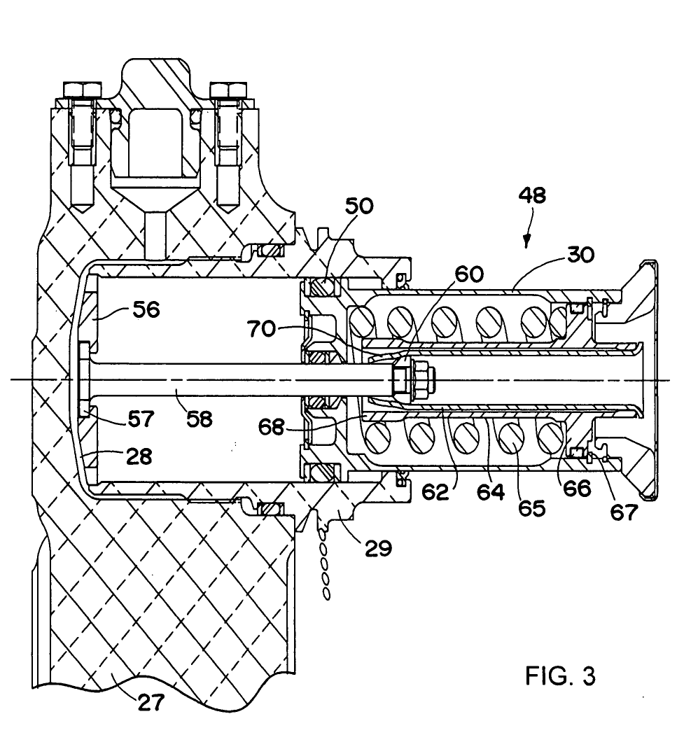

Turning now to FIGS. 2 and 3, the piston 30 is shown with an exemplary wear adjusting mechanism 48 according to the present invention. Accordingly, details of the piston 30 and the wear adjusting assembly 48 shown in FIGS. 2 and 3 will now be described. It is noted that while an exemplary embodiment of the wear adjusting mechanism is shown in relation to the brake assembly 12 shown in FIG. 1, the principles of the invention are applicable to other types of brake assemblies as well.

The illustrated piston 30 is a cup-shaped sleeve with a rearwardly disposed end portion 49 which is suitably recessed to receive an annular seal 50 which slidingly engages the interior wall surface of cylinder 29. The other or front end portion of piston 30 has a piston head 51 suitably connected to the sleeve portion of piston 30. The area between an end wall portion 56 of cylinder 29 and the rearwardly disposed end portion 49 of piston 30 define a chamber which receives pressurized fluids from a suitable pressure source via inlet conduits to move the piston 30 and the piston head 51 against the pressure plate 38 to effect a braking action of the brake stack wherein the interleaved stator and rotor discs are frictionally engaged with each other and against the reaction member.

The wear adjusting mechanism 48 comprises an elongate member, such as rod 58, and a continuous tube 62. The end wall portion 56 of cylinder 29 as shown in FIG. 2 receives an enlarged head 57 of the rod 58 that extends through the rearwardly disposed end portion 49 of the piston 30. This provides an anchor for the rod 58, although other means can be employed to anchor the rod 58. The other end of rod 58 has an expansion member formed, for example, by a radially enlarged device, such as a hardened ball 60, secured thereto by any suitable means, such as by a nut, for engagement with the continuous tube 62. The continuous tube is connected to a tubular member 64 which is encompassed by a compression spring 65. The tubular member 64 and continuous tube 62 are axially coextensive for the most part. The tubular member 64 has a retaining ring or flange 66 and the spring 65 (or other suitable biasing means) is interposed between the flange 66 and the end wall portion 49, whereby a retaining ring 67 is biased against retaining flange 66. The spring functions to urge the piston 30 against the retaining flange of the tubular member 64 which functions as a retraction stroke stop for the piston.

In use, the pressure is applied to the back side of the piston 30 to extend the piston. Initially the piston will move to take up any clearance after which the piston will engage the pressure plate 38 (FIG. 1) to squeeze together the interleaved stator and rotor discs to effect braking. As clamping pressure is applied, the pressure will increase to a point where it equals the force of the spring 65 that holds the piston against the flange of the tubular member 64. After this point, the piston will move forwardly relative to the tubular member 64 until the bottom of the end wall portion 49 of the piston 30 engages a rear end 68 of the tubular member 64, whereupon the piston and tubular member will move forward together. As the piston and tubular member move forward together, the tubular member also advances the continuous tube 62, which engages the hardened ball 60. If the force exerted exceeds the resistance of the continuous tube 62 to movement of the ball 60, the ball will deform the continuous tube radially outwardly as it is drawn through the tube. If there has been no wear of the brake discs, the piston will not extend to a point that will cause the ball to move through the continuous tube. If there has been wear, the piston will move further than it did during a prior braking operation, thereby causing the ball to be drawn through the tube by an amount equal to the extent by which the piston extended during the last braking operation. This in turn will cause the retaining ring 66 to be displaced outwardly relative to the cylinder 29 and thus define a new retraction stroke stop position for the piston.

Upon removal of pressure from the back side of the piston 30, the spring 65 will cause the piston to retract until the flange 67 returns in contact with the retaining ring 66. Consequently, the piston will not return to its original retracted position relative to the cylinder 29 after the brake begins to wear and a prescribed clearance will be reestablished during the time when the brake is not applied. In FIG. 3, the piston is shown in a position corresponding to a substantial amount of wear of the brake discs.

In the past, continuous tubes similar to the continuous tube 62 were cylindrical along the operative length thereof. As the ball neared the end of the continuous tube, the resistance to movement of the ball would decrease because of a reduction in hoop strength of the tube. In accordance with the present invention, the end portion 70 of the continuous tube 62 is processed to increase the hoop strength or otherwise increase the resistance to travel of the ball at the end portion of the continuous tube, thereby to extend the usable portion of the continuous tube. The end portion of the continuous tube can be processed to give the tube over its entire length a more uniform resistance to movement of the ball.

As shown in FIG. 2, the end portion 70 of the continuous tube 62 preferably is radially inwardly flared, as by swaging, for extending the usable portion of the continuous tube, although other configurations are contemplated. The continuous tube preferably is a solid continuous tube that is cylindrical and the end portion progressively decreases in diameter as it approaches its terminal end. Most preferably, the end portion is uniformly radially inwardly flared with a convex curvature as shown in FIG. 2. The wall of the continuous tube preferably is of uniform thickness but the thickness can be varied as may be desired.

Although the invention has been shown and described with respect to certain illustrated embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention. In addition, while a particular feature of the invention may have been described above with respect to only one of several illustrated embodiments, such a feature may be combined with one or more other features of the other embodiment, as maybe desired and advantageous for any given or particular application.

What is claimed is:

1. An adjuster assembly for adjusting the release clearance between selectively engageable friction parts to compensate for wear in such parts, comprising a continuous tube and an expansion member together having a combined length controlling the release clearance of the selectively engageable friction parts, the expansion member having an expansion device frictionally engaging the interior of the continuous tube to effect progressive circumferential expansion of the continuous tube when the expansion device is axially drawn through the continuous tube to compensate for wear of the friction parts during actuation and release of said selectively engageable parts, and the continuous tube having an end portion processed differently from the balance of the continuous tube for extending the usable portion of the continuous tube.

2. An adjuster assembly as set forth in claim 1, wherein the end portion of the continuous tube is shaped to provide over a portion thereof a load resistance essentially equal the load resistance of a cylindrical portion of the continuous tube adjacent the flared end portion.

3. An adjuster assembly as set forth in claim 2, wherein the end portion is radially inwardly flared for extending the usable portion of the continuous tube.

4. An adjuster assembly as set forth in claim 3, wherein the continuous tube is a solid continuous tube.

5. An adjuster assembly as set forth in claim 4, wherein the solid continuous tube is cylindrical and the end portion is uniformly radially inwardly flared.

6. An adjuster assembly as set forth in claim 1, wherein the end portion is radially inwardly flared for extending the usable portion of the continuous tube.

7. An adjuster assembly as set forth in claim 6, wherein the continuous tube is a solid continuous tube.

8. An adjuster assembly as set forth in claim 7, wherein the solid continuous tube is cylindrical and the end portion is uniformly radially inwardly flared.

9. A brake system comprising a plurality of friction discs located between a pressure plate and a reaction plate, an actuating mechanism operative for moving the pressure plate toward the friction discs and the reaction plate, and an adjuster assembly as set forth in claim 1 for compensating for wear of the friction discs.

10. A brake piston adjuster mechanism comprising a deformable tube connected with a piston, a deforming member received with the deformable tube and engaging the deformable tube, wherein the deforming member includes an expander member mounted to an adjuster pin, wherein the deformable tube has a major tube diameter over a major operative portion thereof, and a first end and a second end, wherein during operation over time, the expander member moves from the first end to the second end of the deformable tube, and wherein the second end is provided with an inward swage, such that the second end has a diameter which is smaller than the major tube diameter.

11. A method of increasing the useable life of an adjuster tube in an adjuster assembly that adjusts the release clearance between selectively engageable friction parts to compensate for wear in such parts, the adjuster assembly including a continuous tube and an expansion member together having a combined length controlling the release clearance of the selectively engageable friction parts, and the expansion member having an expansion device frictionally engaging the interior of the continuous tube to effect progressive circumferential expansion of the continuous tube when the expansion device is axially drawn through the continuous tube to compensate for wear of the friction parts during actuation and release of said selectively engageable parts, the method comprising the step of processing an end portion of the continuous tube differently from the balance of the continuous tube for extending the usable portion of the continuous tube.

12. An adjuster assembly as set forth in claim 11, wherein the end portion of the continuous tube is shaped to provide over a portion thereof a load resistance essentially equal the load resistance of a cylindrical portion of the continuous tube adjacent the flared end portion.

13. An adjuster assembly as set forth in claim 12, wherein the end portion is radially inwardly flared for extending the usable portion of the continuous tube.

14. An adjuster assembly as set forth in claim 13, wherein the continuous tube is a solid continuous tube.

15. An adjuster assembly as set forth in claim 14, wherein the solid continuous tube is cylindrical and the end portion is uniformly radially inwardly flared.

16. An adjuster assembly as set forth in claim 11, wherein the end portion is radially inwardly flared for extending the usable portion of the continuous tube.

17. An adjuster assembly as set forth in claim 16, wherein the continuous tube is a solid continuous tube.

18. An adjuster assembly as set forth in claim 17, wherein the solid continuous tube is cylindrical and the end portion is uniformly radially inwardly flared.
